(19) United States
(12) Patent Application Publication
(10) Pub. No.: US 2025/0176757 A1
(43) Pub. Date: Jun. 5, 2025

(54) DETERMINING A VOLUME SIZE OF FOOD

(71) Applicant: BSH Hausgeräte GmbH, Munich (DE)

(72) Inventors: Tim Bender, Karlsruhe (DE); Alejandro Rituerto Sin, Zaragoza (ES); Belen Blanco Abad, Zaragoza (ES); Kerstin Feldmann, Bretten (DE); Benjamin Wagner, Stuttgart (DE)

(21) Appl. No.: 18/842,062

(22) PCT Filed: Feb. 20, 2023
(86) PCT No.: PCT/EP2023/054145

§ 371 Date: Aug. 28, 2024

(30) Foreign Application Priority Data
Mar. 4, 2022 (EP) 22382201.6

(51) Int. Cl. A47J 36/32; A47J 37/00; G06T 7/269; G06V 10/764; G06V 20/68

(52) U.S. Cl. CPC A47J 36/32; A47J 37/00; G06T 7/269; G06V 10/764; G06V 20/68

(57) ABSTRACT

In a method for determining a volumetric variable of food treated in a treatment chamber of a household cooking appliance, images are captured from the treatment chamber in chronological order. Image points belonging to the food are identified in one image of a sequence of images, and a movement direction and a movement speed of the image points using an optical flow method are calculated for subsequent images. Movement directions of previously identified image points are classified into classes for different movement directions and numbers of image points that fall into respective ones of the classes are counted. A variable relating to the volume of the food is counted and the household cooking appliance varies an operating parameter of the household cooking appliance influencing the treatment of the food, when the calculated variable satisfies a specified criterion.

The invention relates to a method for determining a volumetric variable, in particular a change in volume, of food treated in a treatment chamber of a household cooking appliance, wherein images are captured from the treatment chamber in chronological order, in one image of the image sequence, image points belonging to the food are identified, at least one variable relating to the volume of the food is calculated and then if the at least one calculated variable satisfies at least one specified criterion, at least one operating parameter of the household cooking appliance is varied by the household cooking appliance, the operating parameter influencing the treatment of the food. The invention further relates to a household cooking appliance having a treatment chamber which is designed for the heat treatment of food introduced therein, at least one camera for capturing images from the treatment chamber and a data processing facility which is designed to identify image points belonging to the food in one image of a sequence of images, to calculate from the image points at least one variable relating to the volume of the food and then, if the at least one calculated variable satisfies at least one specified criterion, to vary at least one operating parameter of the household cooking appliance influencing the treatment of the food. The invention can be advantageously applied, in particular, to the baking of portions of dough, in particular bread dough.

DE 10 2019 213 638 A1 discloses a cooking appliance, in particular a household cooking appliance, for cooking a food, having a heatable cooking chamber and a control apparatus for carrying out at least one baking program for preparing the food from a starter dough, and having a detection facility which is arranged in the cooking chamber for detecting an optical sensor signal of the food, wherein the control apparatus is designed to carry out the baking program as a function of the detected optical sensor signal of the food. The control apparatus can be designed to determine a volume of the food as a function of the detected optical sensor signal and to carry out the baking program as a function of the determined volume. The control apparatus can comprise an evaluation unit which carries out, for example, an image analysis in order to determine the volume of the food. In particular, during the course of the baking program the control apparatus compares volumetric values determined at different times and thus infers a change in the volume. In this manner, an end time of a dough resting period or a second proving period can be analytically determined. An end time can be determined as a function of a threshold value of the volume. The threshold value can be a percentage value relative to a starting volume, an absolute value, in particular a calculated target value, for the volume. The threshold value can also relate to a value of the change in volume per time unit and, in particular, represent a maximum volume. The control apparatus can be designed to determine a shape of the food as a function of the detected optical sensor signal and to carry out the baking program as a function of the determined shape. Preferably, geometric parameters such as a diameter, a height and/or an edge length are also determined at the same time.

DE 10 2019 107 859 A1 discloses a method for operating a cooking appliance having a cooking region and having a treatment facility for preparing food. The food is monitored in the cooking region during the cooking process. A measurement of the size of the food is repeatedly determined during the cooking process by means of a camera facility. A measurement of the change in size of the food over time is determined therefrom. The food is assigned to at least one food group as a function of the measurement of the change in size. An area of the food can be determined at least approximately from a surface area of the pixels assigned to the food, and a height of the food can be determined at least approximately from a difference between the spacings of the pixels assigned to the food and the pixels which are adjacent to the food but not assigned thereto, and a volume of the food can be determined at least approximately from the area and the height, and a change in volume over time can be used as a measurement of the change in size of the food. A time curve of an estimated value of the food volume can be continuously documented at the start and during cooking. An electronics unit can continuously analyze the time curve of the estimated value of the food volume, in cooperation with the selected cooking program, and intervene in the regulation of the cooking program. This can take place, for example, by changing the cooking chamber temperature, assistance in consultation with the user toward the end of the cooking time and independent termination of the cooking process. As a result of this analysis or information, the electronics unit then intervenes in the cooking process, for example by switching off the heating and other energy supply, and if required by keeping the food warm or (rapidly) cooling it down.

DE 10 2019 107 812 A1 discloses a method for operating a cooking appliance having a cooking region for preparing food, wherein the food is monitored in the cooking region during the cooking process and wherein to this end images of the cooking region are detected over time by means of a camera facility, wherein the images in each case consist of a plurality of pixels and are evaluated by means of a processing facility. Pixels which change over time are identified and assigned as belonging to the food, in order to permit a differentiation from the pixels originating from outside the food. This makes use of the fact that pixels which contain food behave completely differently from pixels which contain the cooking region having the cooking chamber walls, vessels, and the like. This difference relates not only to the change due to browning and coloration but, for example, also to spacings due to a change in volume or changes to the surface temperature. The images detected by means of the camera facility can contain spatial image information from the cooking region, wherein at least one chronological change in the spatial image information, preferably a spatial change relative to the camera facility, is evaluated for identifying the pixels which change over time.

DE 10 2019 212 364 A1 discloses a method for operating a household cooking appliance having a cooking chamber and at least one camera which is designed to capture images from the cooking chamber on the basis of image points, in which (a) at least one image is captured from the cooking chamber by means of the at least one camera and (b) the image is evaluated by excluding the brightness values of its associated image points.

It is the object of the present invention to remedy at least partially the drawbacks of the prior art and, in particular, to provide a robust possibility which can be easily implemented for calculating a variable relating to a volume of a heat-treated food from an image sequence.

This object is achieved according to the features of the independent claims. Preferred embodiments can be found, in particular, in the dependent claims.

The object is achieved by a method for determining a volumetric variable of food treated in a treatment chamber of a household cooking appliance, wherein
images are captured from the treatment chamber in chronological order,
in particular in a first image of the image sequence, image points belonging to the food are identified,
for subsequent images, a movement direction and a movement speed of the image points are calculated using the optical flow method, in particular the dense optical flow method,
the movement directions of the previously identified image points are classified into classes for different movement directions,
the numbers of image points that fall within the respective classes are counted,
from the numbers, at least one variable relating to the volume of the food is calculated, and
then, if the at least one calculated variable satisfies at least one specified criterion, at least one operating parameter of the household cooking appliance is varied by the household cooking appliance, the operating parameter influencing the treatment of the food.

This method provides the advantage that the variable relating to the volume of the heat-treated food can be reliably determined irrespective of the size of the food, the position of the food and the type of food container.

The household cooking appliance can be, for example, an oven, a steam treatment appliance, a microwave appliance, a food processor or any combination thereof, for example an oven with a steam treatment, in particular steam cooking, functionality. The treatment chamber can also be denoted as the cooking chamber, even if the food is not cooked therein but is treated, for example by being moistened at room temperature.

The method is particularly advantageous when the food is subjected to a noticeable change in volume at least during a time period of its treatment. It is a development that the food is a portion of dough, for example consists of bread dough, etc.

The chronological sequence can encompass, for example, the capturing of images at intervals of several seconds to minutes, for example every 5 s, 10 s, 30 s, 1 min, 2 min, or the like.

The fact that images are captured from the treatment chamber encompasses, in particular, that the food located in the treatment chamber is also illustrated on the images.

It is a development that at least some of the images are captured by means of a camera of the household cooking appliance. The camera can be arranged, for example, in the region of a ceiling, a side wall or a rear wall of the wall of the treatment chamber (which can also be denoted as a muffle) or on a door closing a loading opening of the treatment chamber. It is a development that the camera is oriented obliquely into the treatment chamber, which is advantageous in order to detect a movement of the food in the vertical direction. The camera can also be denoted as the cooking chamber camera. The camera is, in particular, a pixel-based digital camera, specifically a digital color camera.

The household cooking appliance can have one or more cooking chamber cameras. The method can be carried out using the images from only one camera or using the images from a plurality of cameras.

The identification of the sequence of image points belonging to the food can also be denoted as segmentation. The identification can be carried out, for example, by object recognition, determination of brightness and/or color differences (for example dark cooking chamber wall, food support and food containers, light-colored food), etc.

The one image in which the image points are identified can be, in particular, the first image of the image sequence which is used for carrying out the method.

The optical flow method, in particular also the dense optical flow method, is known in principle. The movement of the objects present in the images is detected by tracking the image points which are characteristic of the objects over a sequence of images, in particular from image to image. For each of the image points in the image plane, a movement direction which is represented, in particular, in polar coordinates (represented by the polar angle φ) and a movement speed (represented by the radius r) is produced for successive images. This corresponds to the assignment of a vector relative to one respective image point located in the image plane, wherein the direction of the vector corresponds to the movement direction of the image point and its length corresponds to the movement speed. This movement can be continued over more than two images. In particular, the path of the movement of the image points in the image plane can also be reproduced for a plurality of images.

The fact that the movements of the previously identified (“segmented”) image points are classified into classes for different movement directions encompasses, in particular, that only the movements of the previously identified image points are classified into classes for different movement directions.

It is a development that the optical flow method is applied only to the image points previously belonging to the food. It is a particularly advantageous development that the optical flow method is applied to all of the image points and then only the image points identified as belonging to the food are considered further. It is a development that, for all of the images of the image sequence used, the identified image points correspond to the image points identified in the first image.

The classification of the movements of the image points for different movement directions encompasses, in particular, that it is monitored whether the movement directions determined by the optical flow method are, or are not, in a specific relationship with at least one specified movement direction. If this is the case, the associated image point is assigned to a class which is assigned to this movement direction, or otherwise not. Thus there is the possibility that none of the previously identified image points is assigned to at least one of the classes but remains “classless” for the entire treatment sequence or time periods thereof.

It is a development that the image points are classified unweighted, i.e. each image point has the same unit value, for example “1”. The number of a class corresponds, therefore, exactly to the number of image points in this class.

It is a development that the image points are classified unweighted, i.e. a weighting factor is assigned to each image point, whereby a “weighted number” is assigned to each image point. As a result, different image points can contribute to the (total) number in the classes to a different extent. It is a development that the weighting is a function of the movement speed of the respective image point. For example, the greater the movement speed, the greater the weighting factor and thus the weighted number. In particular, the weighting factor can be a function of the movement speed, in particular proportional to the movement speed.

It is a development that the different movement directions encompass movements in opposing directions along the same axis. It is a development that the different movement directions encompass movements in opposing directions along the plurality of axes.

The fact that at least one variable relating to the volume of the food is calculated from the numbers encompasses, in particular, that this variable is derived or estimated from the absolute value and/or the relation(s) between the numbers of at least two classes to one another. The relationship can also encompass the number of classless image points. The relationship can encompass, for example, a relation between the numbers of different classes and/or the classless image points, a relation to a threshold value, etc. The relationship between the numbers and the at least one variable can be determined, for example, by experiments, simulations and/or machine learning, etc. The relationship can be stored, for example, in the form of a table or a function with the numbers as variables in the household cooking appliance.

Satisfying the at least one specified criterion can encompass satisfying a condition or relation, satisfying a condition from a group of a plurality of conditions and/or simultaneously satisfying at least two conditions from a group of a plurality of conditions. The criterion can encompass, for example, reaching, exceeding and/or falling below at least one specified threshold value.

It is a development that the criterion encompasses satisfying at least one relationship of the numbers assigned to the respective classes and optionally the number of classless image points. In this development, therefore, a physical variable relating to the volume is not explicitly calculated but the at least one variable relating to the volume is implicitly or analogously provided by the relationship of the numbers.

It is an embodiment that the different movement directions encompass a movement in the direction of gravity and a movement counter to the direction of gravity, i.e. movements in opposing movement directions along the axis of gravity (“gravity axis”). This provides the advantage that it is possible to monitor in a particularly simple manner whether the food moves upwardly or rises (hereinafter also denoted as “rise”) or whether it moves downwardly or falls (hereinafter also denoted as “fall”). In addition, a quantitative determination of the rise and fall can thus be implemented in a particularly simple manner. The gravity axis corresponds in a very good approximation to the vertical, in particular downwardly oriented, spatial axis. The gravity axis can be determined in the image of a camera by the geometric arrangement and orientation thereof, and namely irrespective of loading with food.

It is an embodiment that an image point is assigned to a first class (corresponding to the rise) when it moves within a first specified angular deviation relative to the gravity axis counter to the direction of gravity, and is assigned to a second class (corresponding to the fall) when it moves within a second specified angular deviation relative to the gravity axis in the direction of gravity. Thus the advantage is achieved that a particularly simple classification which delivers reliable results is provided.

The fact that an image point moves within a specified angular deviation relative to a specific reference axis encompasses, in particular, that a movement direction of the image point in the image plane has an angular deviation relative to the reference axis which is not greater than or less than the specified angular deviation. The angular deviation can be symmetrical or asymmetrical to the axis, i.e. the size of the clockwise angular deviation and the size of the counterclockwise angular deviation can be the same or different.

It is a development that an image point is classified into the first class when the clockwise angular deviation relative to the downwardly oriented gravity axis is located in the angular ranges [φ₁ₗ; φ₁ᵤ] or ]φ₁ₗ; φ₁ᵤ[, wherein the boundary conditions 90°<φ₁ₗ≤180° and 180°≥φ₁ᵤ<270° apply.

It is a particularly advantageous development for a reliable and robust determination of the variable relating to the volume that 150°≤φ₁ₗ≤160° is selected and/or 200°≤φ₁ᵤ≤210° is selected. Generally 180°−φ₁ₗ=φ₁ᵤ−180° (symmetrical angular deviation) can apply or 180°−φ₁ₗ<>φ₁ᵤ−180° (asymmetrical angular deviation) can apply.

It is a development that an image point is classified into the second class when the clockwise angular deviation relative to the downwardly oriented gravity axis is located in the angular ranges [φ₂ₗ; φ₂ᵤ] or ]φ₂ₗ; φ₂ᵤ[, wherein the boundary conditions 270°<φ₂ₗ≤360°≡0° and 0°≥φ₂ᵤ>90° apply.

It is a particularly advantageous development for a reliable and robust determination of the variable relating to the volume that 330°≤φ₂ₗ≤340° is selected and/or 20°≥φ₂ᵤ>30° is selected. Generally 360°−φ₂ₗ=φ₂ᵤ (symmetrical angular deviation) or 360°−φ₂ₗ<>φ₂ᵤ (asymmetrical angular deviation) can apply.

For example, if the reference axis is the downwardly oriented gravity axis and the first and second angular deviations are symmetrical, for example with a value of 20°, those image points whose movement directions are within an angular range of [−20°; +20°] or ]−20°; +20°[ relative to the gravity axis are classified into the first class, and those image points whose movement directions are within an angular range [160°; 200°] or ]160°; 200°[ relative to the gravity axis are classified into the second class.

It is one embodiment that the different movement directions encompass a movement away from a center of gravity of the surface of the food and a movement toward the center of gravity of the surface of the food. This achieves the advantage that additionally or alternatively to the rise and fall, a side or lateral widening of the food (hereinafter also denoted as an “expansion”) and a lateral narrowing of the food (hereinafter denoted as a “contraction”) can also be taken into consideration in order to calculate the at least one variable of the food relating to the volume.

It is a development that the center of gravity of the surface corresponds to the geometric center of gravity of the segmented image point in the image plane.

It is one embodiment that a center of gravity of the surface of the food is determined and one respective connecting line relative to the center of gravity of the surface is determined for the image points belonging to the food, and an image point is assigned to a third class (corresponding to the expansion) when it moves within a third specified angular deviation relative to a connecting line away from the center of gravity of the surface, and is assigned to a fourth class (corresponding to the contraction) when it moves within a fourth specified angular deviation relative to a connecting line toward the center of gravity of the surface. This achieves the advantage that a reliable measurement of the expansion and contraction of the food is provided in a manner which can be implemented particularly simply.

The fact that an image point moves away from the center of gravity of the surface within a specified angular deviation relative to the connecting line encompasses, in particular, that a movement direction of the image point in the image plane has an angular deviation relative to the connecting axis, oriented from the center of gravity of the surface to this image point, which is not greater than or less than the specified third angular deviation. The fact that an image point moves toward the center of gravity of the surface within a specified angular deviation relative to the connecting line encompasses, in particular, that a movement direction of the image point in the image plane has an angular deviation in the opposing direction of the connecting axis, oriented from the center of gravity of the surface to this image point, which is not greater than or less than the specified fourth angular deviation. The angular deviation can be symmetrical or asymmetrical relative to the connecting axis.

It is a development that an image point is classified into the third class when the clockwise angular deviation relative to the connecting axis oriented away from the center of gravity of the surface is located in the angular ranges [φ₃ₗ; φ₃ᵤ] or ]φ₃ₗ; φ₃ᵤ[, wherein the boundary conditions 270°<φ₃ₗ≤360°≡0° and 0°≥φ₃ᵤ>90° apply.

It is a particularly advantageous development for a reliable and robust determination of the variable relating to the volume that 330°≤φ₃ₗ≤360° is selected and/or 0°≥φ₃ᵤ>30° is selected. Generally 360°−φ₃ₗ=φ₃ᵤ (symmetrical angular deviation) or 360°−φ₃ₗ<>φ₃ᵤ (asymmetrical angular deviation) can apply. Generally 180°−₁ₗ=φ₁ᵤ−180° (symmetrical angular deviation) or 180°−φ₁ₗ<>φ₁ᵤ−180° (asymmetrical angular deviation) can apply. It is a particularly advantageous development that φ₃ₗ=360° applies, i.e. that an image point is classified into the third class only under the condition that the angular deviation of its movement direction is located within the angular range [0°; φ₃ᵤ], for example within the angular range [0°; 30°].

It is a development that an image point is classified into the fourth class when the clockwise angular deviation relative to the connecting axis is located in the angular ranges [φ₄ₗ; φ₄ᵤ] or ]φ₄ₗ; φ₄ᵤ[, wherein the boundary conditions 90°<φ₄ₗ≤180° and 180°≥φ₄ᵤ<270° apply.

It is a particularly advantageous development for a reliable and robust determination of the variable relating to the volume that 150°≤φ₄ₗ≤160° is selected and/or 180°≤φ₄ᵤ≤210° is selected. Generally 180°−φ₁ₗ=φ₁ᵤ−180° (symmetrical angular deviation) or 180°−φ₁ₗ<>φ₁ᵤ−180° (asymmetrical angular deviation) can apply. It is a particularly advantageous development that φ₄ᵤ=180° applies, i.e. that an image point is classified into the fourth class only under the condition that the angular deviation of its movement direction is located within the angular range [φ₄ₗ; 180°], for example within the angular range [150°; 180°].

For example, if the third and fourth angular deviations relative to the connecting axis, serving as a reference axis, are symmetrical, for example specified to 25°, those image points whose movement directions are located within an angular range of [−25°; +25°] or ]25°; +25°[ in the direction of the connecting axis facing away from the center of gravity of the surface would be classified into the third class, and those image points whose movement directions are within a range [160°; 200°] or ]160°; 200°[ relative to the connecting axis would be classified into the fourth class.

It is one embodiment that an image point is assigned to a specific class only when its movement speed is above a specified threshold value. Thus the determination of the variable relating to the volume is more robust, since image points which are classified then have a minimum speed and as a result barely moving image points are not taken into consideration.

It is a development that the movement speed corresponds to the scalar length of the movement vector of the respective image point.

It is a development that the image points in the image belonging to the food are identified using their color. This can be implemented particularly simply and is based on the recognition that food typically has a noticeably different color from the generally dark blue, dark gray or black cooking chamber wall, the generally black baking sheet and the generally silver-colored oven rack and food containers. This applies, in particular, to fresh dough which typically has a light brown color. Image points whose color coordinates are in a subspace of the color space of the image specified for the color of the introduced food are assigned to the food but, in particular, other image points are not assigned.

It is a development that the captured image is an RGB image, i.e. the possible colors of the image points are thus in the RGB color space.

It is a development which can be implemented in a particularly simple manner that the image points in the image belonging to the food are identified by the H-values thereof relative to an HSV (“Hue, Saturation, Value”) color coordinate system being located within a specified value range. This results in the advantage that the association of an image point with light brown food can be reliably determined using only one coordinate axis of the color space, namely its position on the H-axis. This utilizes the fact that, in the HSV color space, brown tones are located on the H-axis, which is advantageous in particular for brown food, in particular light brown food, in particular dough.

As a result, for example, image points belonging to a portion of dough can be identified by the values thereof being located on the H-axis (“H values”) within a value range which is defined by a lower threshold value (lower “H-threshold value”) and an upper threshold value (upper “H-threshold value”) and which comprises the brown tones of typical portions of dough.

If an image is captured in a different color space from the HSV color space (for example as an RGB image), the color coordinates of the image points can be calculated or transformed from the original color space into the HSV color space.

Alternatively to the HSV color space, an HSL (“Hue, Saturation, Lightness”) color space can also be advantageously used, in particular adapted relative to limit values.

It is one embodiment that the at least one variable relating to the volume of the food encompasses at least one variable from the group: volume of the food, chronological change in the volume of the food and/or speed of change of the volume of the food.

It is one embodiment that the at least one specified criterion encompasses reaching a maximum volume of the food and/or reaching a minimum change in the volume of the food. This achieves the advantage that reaching an extreme value and/or approaching a stationary value of the volume can be particularly easily identified, in particular reaching a maximum volume of the food and/or reaching a slightest change in volume. The minimum change in volume can be assumed, for example, when the change in volume, in particular an increase in volume, of the food between two successive images is less than a specified threshold value.

It is one embodiment that the at least one operating parameter influencing the treatment of the food encompasses at least one operating parameter from the group: temperature in the treatment chamber (which can also be denoted as “cooking chamber temperature”) and/or humidity in the treatment chamber. This results, in particular, in the advantage for food reacting sensitively to the cooking chamber temperature and/or the humidity in the treatment chamber, by changes in volume, that the treatment of the food can be adapted particularly reliably and promptly to the occurrence of specific food states, and thereby the cooking result can be improved.

It is one embodiment that the food is dough. The method can be applied particularly advantageously to such food, since in the case of dough the volume thereof and/or the change in volume thereof is a particularly reliable indicator of the presence and/or the termination of specific treatment phases. If the treatment phases, in particular the end thereof, can be more reliably determined, the result of the preparation of the food is also noticeably improved.

It is a development that the dough is bread dough, since the volume thereof for bread dough or a variable which can be derived therefrom can be particularly easily detected and bread dough also has different treatment phases which exhibit a noticeably different volume behavior and which require different ambient conditions for a particularly successful result.

In the case of baking bread, in a first phase with high air humidity and high cooking chamber temperatures the dough is subjected to a significant increase in volume (so-called “dough rise”). This is followed by a transition to a second phase (so-called “final baking” or “browning”) in which the bread dough maintains its volume or even slightly reduces this volume by generating a browned crust. The second phase typically uses lower temperatures and a lower humidity in the cooking chamber than the first phase and lasts longer than the first phase. The more accurate the transition time between the two phases is able to be determined in order to adapt the cooking chamber atmosphere (in particular relative to the cooking chamber temperature, but also relative to the degree of humidity and/or the heating elements then used), the better the baking result.

It is one embodiment that when a maximum volume of dough and/or a minimum change in the volume of dough is reached, a temperature and/or a humidity in the treatment chamber is reduced. Thus a particularly successful result can be achieved when the dough rising phase transitions to the browning phase.

The object is also achieved by a household cooking appliance, having
a treatment chamber which is designed for the heat treatment of food introduced therein,
at least one camera for capturing images from the treatment chamber, and
a data processing facility which is designed
to identify image points belonging to the food in one image of a sequence of images,
to calculate for subsequent images a movement direction and a movement speed of the image points by means of the optical flow method, in particular the dense optical flow method,
to classify the movements of the previously identified image points into classes for different movement directions,
to count the number of image points which fall within the respective classes,
to calculate from the numbers at least one variable relating to the volume of the food, and
then, if the at least one calculated variable satisfies at least one specified criterion, to vary at least one operating parameter of the household cooking appliance influencing the treatment of the food.

The household cooking appliance can be configured similarly to the method and vice versa, and has the same advantages.

The above-described properties, features and advantages of this invention and the manner in which they are achieved will become clearer and more comprehensible in connection with the following schematic description of an exemplary embodiment which is explained in more detail in connection with the drawings.

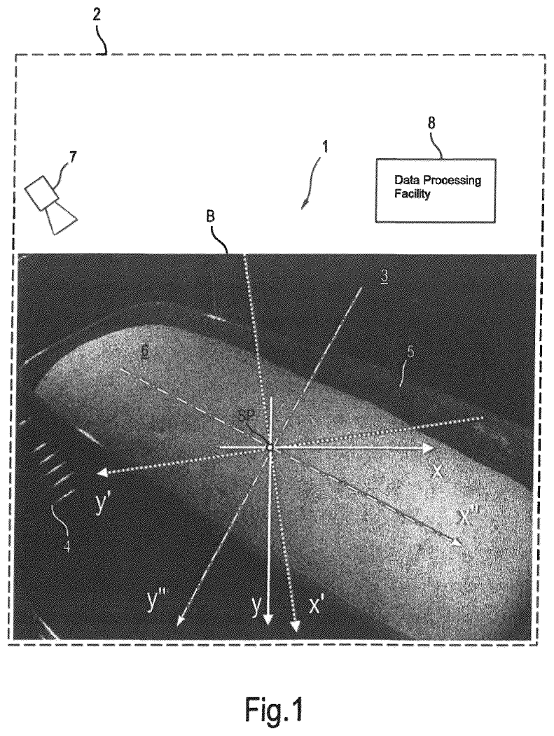

FIG. 1 shows an image which is captured from a treatment chamber in which a surface of bread dough is illustrated and in which a plurality of coordinate systems are illustrated;

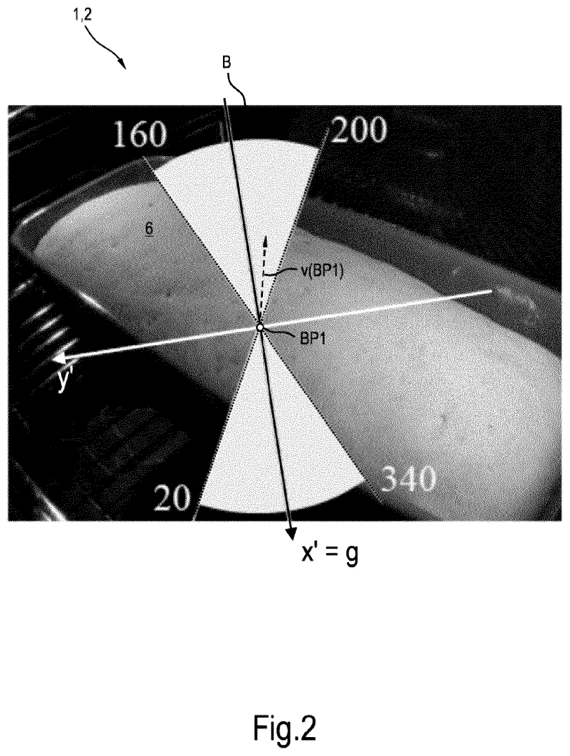

FIG. 2 shows the image from FIG. 1 with the gravity axis;

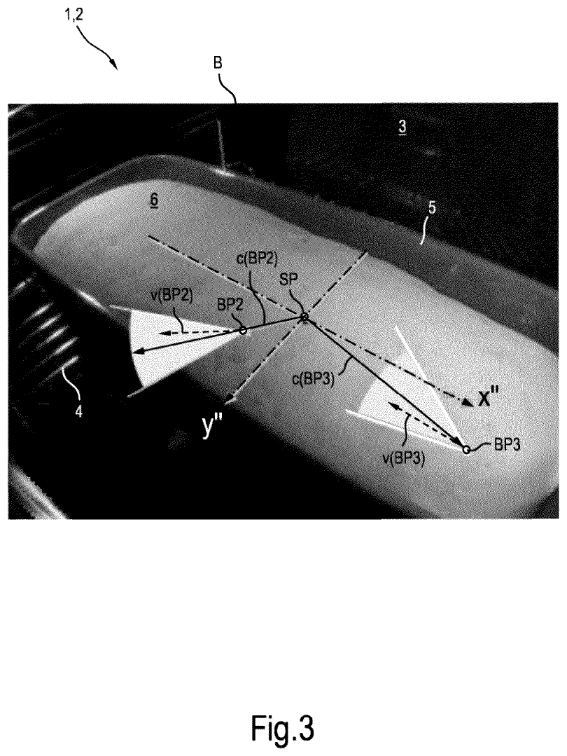

FIG. 3 shows the image from FIG. 1 with the connecting axis between the center of gravity of the surface and the image point; and

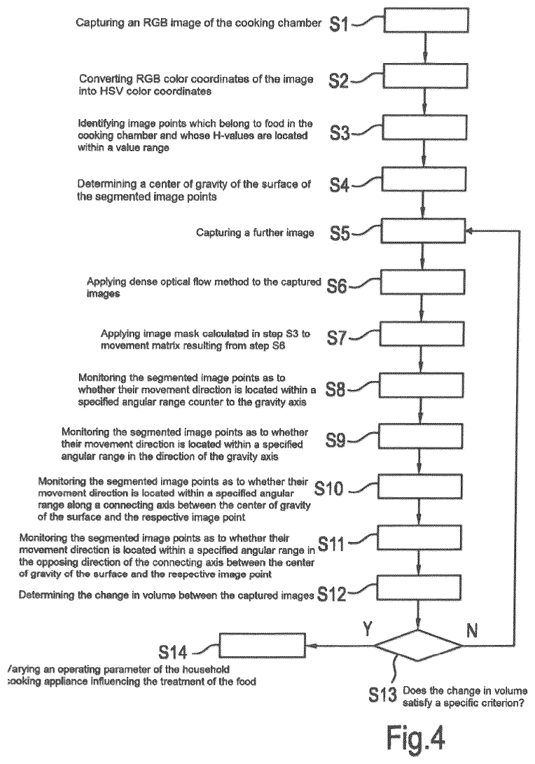

FIG. 4 shows a possible method sequence for carrying out the method.

FIG. 1 shows a color image B captured from a treatment chamber in the form of a cooking chamber 1 of a household cooking appliance 2 by means of a digital camera 7. The household cooking appliance 2 can be, for example, an oven having an additional steam treatment functionality, for example so-called “added steam”. A cooking chamber wall 3, an oven rack 4, a box-shaped baking tin 5 deposited on the oven rack 4 and a portion of dough 6, in particular consisting of bread dough, which is placed in the baking tin 5 are in the image B. The image B has typically p image points in its x-direction or along its x-axis x and q image points in its y-direction or along its y-axis, for example 640×480 image points, 1024×768 image points, etc. The x-axis and the y-axis intersect here in the geometric center of gravity of the surface SP of the image points belonging to the portion of dough 6.

Additionally illustrated are the cartesian coordinate axes x′ and y′ which also intersect in the geometric center of gravity of the surface SP, the axis x′ thereof corresponding to the downwardly oriented gravity axis and thus also being able to be denoted as “g”. The gravity axis g is identical for all image points. The gravity axis x′ or g results from the arrangement and orientation of the camera 7 and is thus independent of the presence of the portion of dough 6. The (x′, y′) coordinate system here is rotated relative to the (x, y) coordinate system.

Additionally illustrated are the cartesian coordinate axes x″ and y″ which also intersect in the geometric center of gravity of the surface SP, the axis x″ thereof being oriented in the longitudinal direction of the portion of dough 6. The optional use of this coordinate system is advantageous in order to relate the movement of the image points with the food in a particularly simple manner.

The household cooking appliance 2 also has a data processing facility 8 which is coupled to the camera 7 in terms of data technology and which can activate the camera 7 for capturing images and is also designed, for example is programmed, to process the images B transmitted from the camera 7, for example, in order to calculate a variable relating to a volume of the portion of dough 6, for example a change in volume over time. The data processing facility 8 can also be designed to vary at least one operating parameter influencing the treatment of the portion of dough 6, such as a cooking chamber temperature, a humidity, etc. The data processing facility 8 can be, in particular, a central control facility of the household cooking appliance 2.

FIG. 2 shows the image B from FIG. 1 with the gravity axis g illustrated by an image point BP1 assigned to the portion of dough 6. A movement vector v(BP1) calculated by the dense optical path method from chronologically successive images B can be assigned to the image point BP1. The movement vector v(BP1) can be expressed as a scalar product of its scaled movement direction and its length, in particular in polar coordinates r (length) and φ (angle relative to gravity axis g).

Also illustrated is a first angular range [160°; 200°] in the direction of gravity or ±20° counter to the direction of gravity (corresponding to the direction counter to the gravity axis g). If the movement vector v(BP1) is within the first angular range, this can be regarded as a rise of the portion of dough 6 at the location of this image point BP1.

Also illustrated is a second angular range [340°; 20°] or ±20° in the direction of gravity (corresponding to the direction along the gravity axis g). If the movement vector v(BP1) is within the second angular range, this can be regarded as a fall of the portion of dough 6 at the location of this image point BP1.

FIG. 3 shows the image B from FIG. 1 with a connecting axis c(BP1) between the center of gravity of the surface SP and an image point BP2 as well as with a connecting axis c(BP2) between the center of gravity of the surface SP and an image point BP3 of the portion of dough 6. The connecting axes c(BP2) and c(BP3) face from the center of gravity of the surface SP to the respective image point BP2 or BP3.

Also illustrated are the movement vectors v(BP2) and v(BP3) of the image points BP2 or BP3. While the movement vector v(BP2) within the illustrated third angular range faces away from the center of gravity of the surface SP, for example by ±20° along the connecting axis c(BP2), the movement vector v(BP3) within the illustrated fourth angular range faces toward the center of gravity of the surface SP, for example by ±20° in the opposing direction of the connecting axis c(BP3). This can be interpreted as meaning that the portion of dough expands at the location of the image point BP2 but contracts at the location of the image point BP3.

It is possible that none, some or all image points assigned to the portion of dough 6 have movement vectors v which are within the first or second angular range and/or which are within the third or the fourth angular range. It is also possible that none, some or all image points assigned to the portion of dough 6 have movement vectors v which are not located in any of the angular ranges.

FIG. 4 shows a possible method sequence for carrying out the method for baking bread.

After loading the cooking chamber 1 with the portion of dough 6, for example controlled by means of the data processing facility 8, a treatment process for bread baking is started. In a first step S1, for example controlled by the data processing facility 8, a first RGB image B₁ of the cooking chamber including the grill rack 4, the baking tin 5 and the portion of dough 6 is captured by means of a color digital camera 7, for example similar to the image B from FIG. 1.

In a step S2, the RGB color coordinates of the image B₁ are converted into HSV (Hue, Saturation, Value) color coordinates, for example by the data processing facility 8.

In a third step S3, for example by means of the data processing facility 8, an identification takes place of those image points whose H-values are located within a value range which is defined by a lower threshold value (lower “H-threshold value”) and an upper threshold value (upper “H-threshold value”), and which corresponds in particular to a light brown of a fresh portion of dough 6. The result of this “segmentation” is an image mask in which all of the detected image points are assigned specific information, for example “1”, and all other image points are assigned different information, for example “0”. It is assumed therefrom that only the image points assigned to the portion of dough 6 are within the specified value range. These image points can also be denoted as “segmented” image points.

It is a development that this image mask is determined once from the first image B₁ and then maintained unchanged for the remainder of the method.

In a fourth step S4, for example by means of the data processing facility 8, the center of gravity of the surface SP of the segmented image points assigned to the portion of dough 6 is determined or calculated, for example the geometric center of gravity.

In a fifth step S5, for example controlled by the data processing facility 8, a further image Bᵢ is captured, where i=2.

In a sixth step S6, for example by means of the data processing facility 8, the dense optical flow method is applied to the images Bᵢ and Bᵢ₋₁. The resulting movement vector v for each of the image points in the (x, y) image plane is initially transformed from the cartesian coordinate system into a movement vector v of a polar coordinate system, the length r thereof specifying its movement speed and the polar angle φ thereof specifying its movement direction. The result is a movement matrix with x·y movement vectors v which in each case are assigned to the image points located at the same matrix position. The movement matrix thus permits an estimation of the movement of the individual image points.

In a seventh step S7, for example by means of the data processing facility 8, the image mask calculated in step S3 is applied to the movement matrix resulting from step S6, in particular by scalar multiplication of the corresponding image points, so that as a result only the movement vectors assigned to the image points of the portion of dough 6 are maintained, and the remaining image points are assigned no movement vector or a movement vector having a zero length. In other words, this generates a movement matrix in which only the movement vectors assigned to the image points of the portion of dough 6 are taken into consideration.

In a step S8, for example by means of the data processing facility 8, the segmented image points are monitored as to whether their movement direction is located within a specified first angular range counter to the gravity axis g, i.e. a rise has taken place at these image points. If this is the case, the image point is classified into a first class or assigned to the first class. The number n₁ of all such image points results from step S8.

In a step S9, for example by means of the data processing facility 8, the segmented image points are monitored as to whether their movement direction is located within a specified second angular range in the direction of the gravity axis g, i.e. a fall has taken place at these image points. If this the case, the image point is classified into a second class or assigned to the second class. The number n₂ of all such image points results from step S9.

In a step S10, for example by means of the data processing facility 8, the segmented image points are monitored as to whether their movement direction is located within a specified third angular range along a connecting axis between the center of gravity of the surface SP and the respective image point, i.e. an expansion has taken place at these image points. If this is the case, the image point is classified into a third class or assigned to the third class. The number n₃ of all such image points results from step S10.

In a step S11, for example by means of the data processing facility 8, the segmented image points are monitored as to whether their movement direction is located within a specified fourth angular range in the opposing direction of the connecting axis between the center of gravity of the surface SP and the respective image point, i.e. a contraction has taken place at these image points. If this is the case, the image point is classified into a fourth class or assigned to the fourth class. The number n₄ of all such image points results from step S10.

In step S12, for example by means of the data processing facility 8, the change in volume ΔV between the image capturing of the images Bᵢ₋₁ and Bᵢ is determined from the numbers n₁ and n₂ and/or from the numbers n₃ and n₄.

In step S13, for example by means of the data processing facility 8, it is monitored as to whether the change in volume ΔV satisfies at least one specific criterion, for example according to ΔV<ΔVₜₕᵣ is less than or according to ΔV≤ΔVₜₕᵣ is less than or equal to a specified positive threshold value ΔVₜₕᵣ , where ΔV=0 applies or ΔV<0 applies. These criteria correspond to the state of the portion of dough 6 in which its volume V barely increases, or even has already slightly shrunk, which indicates the transition from rising to browning.

If the change in volume ΔV does not satisfy the at least one criterion (“N”) the method branches back to step S5 and a further image Bᵢ where i: =i+1. It is particularly advantageous if approximately 10 s elapse between the capturing of images Bᵢ and Bᵢ₊₁.

However, if the change in volume ΔV does satisfy the at least one criterion (“Y”), in step S14, for example by means of the data processing facility 8, in one development at least one operating parameter of the household cooking appliance influencing the treatment of the portion of dough 6 is varied, for example the cooking chamber temperature is lowered, the air humidity is reduced, etc. as a function of the type of food, in particular the portion of dough 6, for example whether different types of bread dough, croissant dough, etc. are used.

Rotation matrices can be used for calculating the angular difference between the movement vectors v of the image points and the relevant reference axis g or c.

Naturally the present invention is not limited to the exemplary embodiment shown.

Thus the steps S8 to S11 can be performed in any sequence.

Moreover, the angular ranges can be fixedly specified or adjustable in a variable manner, for example as a function of an operating program used or a known food.

Moreover, optionally the length |r| of the movement vectors can be considered, for example by the classification of image points which have a specified minimum length |r|ₘᵢₙ or the length |rₚᵣₒⱼ| thereof projected onto the respective reference axis (gravity axis g, connecting axis c) having a specified minimum length |rₚᵣₒⱼ|ₘᵢₙ. In one development, only the image points which have a sufficient length are classified. In a further development, initially the image points which do not have a sufficient length are also classified and these image points are then deleted again from the classes at the end of steps S8 to S11.

Moreover, the number n₅ of the image points not classified in any of the classes can be used to determine the change in volume ΔV between the captured images of the images Bᵢ₋₁ and Bᵢ.

Generally “a”, “one” etc. can be understood to mean a singular or a plurality, in particular in the sense of “at least one” or “one or more”, etc., provided this is not explicitly excluded, for example by the expression “exactly one”, etc.

A numerical specification can also encompass exactly the specified number and also a usual tolerance range, provided this is not explicitly excluded.

### LIST OF REFERENCE CHARACTERS

1 Cooking chamber
2 Household cooking appliance
3 Cooking chamber wall
4 Oven rack
5 Baking tin
6 Portion of dough
7 Camera
B Image
BP1 Image point
BP2 Image point
BP3 Image point
c Connecting axis
SP Center of gravity
S1-S14 Method steps
v Movement vector
x x-axis
x′ x′-axis
x″ x″-axis
y y-axis
y′ y′-axis
y″ y″-axis
Gravity axis

1-12. (canceled)

13. A method for determining a volumetric variable of food treated in a treatment chamber of a household cooking appliance, the method comprising:
capturing images from the treatment chamber in chronological order;
identifying image points belonging to the food in one image of an image sequence;
calculating for subsequent images a movement direction and a movement speed of the image points using an optical flow method, in particular a dense optical flow method;
classifying movement directions of previously identified image points into classes for different movement directions;
counting numbers of image points that fall into respective ones of the classes;
calculating from the numbers a variable relating to the volume of the food; and
varying by the household cooking appliance an operating parameter of the household cooking appliance influencing the treatment of the food, when the calculated variable satisfies a specified criterion.

14. The method of claim 13, wherein the different movement directions encompass a movement in a direction of gravity and a movement counter to the direction of gravity.

15. The method of claim 14, further comprising:
assigning an image point to a first class when the image point moves within a first specified angular deviation relative to a gravity axis counter to the direction of gravity; and
assigning the image point to a second class when the image point moves within a second specified angular deviation relative to the gravity axis in the direction of gravity.

16. The method of claim 13, wherein the different movement directions encompass a movement away from a center of gravity of a surface of the food and a movement toward the center of gravity of the surface of the food.

17. The method of claim 16, further comprising:
determining the center of gravity of the surface of the food;
determining a connecting line relative to the center of gravity of the surface for the image points belonging to the food;
assigning an image point to a third class when the image point moves within a third specified angular deviation relative to the connecting line away from the center of gravity of the surface; and
assigning the image point to a fourth class when the image point moves within a fourth specified angular deviation relative to the connecting line toward the center of gravity of the surface.

18. The method of claim 13, further comprising assigning an image point to a specific class only when the movement speed of the image point is above a specified threshold value.

19. The method of claim 13, further comprising identifying the image points in the image belonging to the food by H-values thereof relative to an HSV (“Hue, Saturation, Value”) color coordinate system being located within a specified value range.

20. The method of claim 13, wherein the variable relating to the volume of the food encompasses at least one variable selected from the group consisting of volume of the food, change in volume of the food, and speed of change of the volume of the food.

21. The method of claim 13, wherein the specified criterion encompasses reaching a maximum volume of the food and/or reaching a minimum change in the volume of the food.

22. The method of claim 13, wherein the operating parameter influencing the treatment of the food encompasses at least one operating parameter selected from the group consisting of temperature in the treatment chamber, and humidity in the treatment chamber.

23. The method of claim 13, wherein the food is dough, in particular bread dough, the method further comprising reducing a temperature and/or a humidity in the treatment chamber when a maximum volume of the dough and/or a minimum change in a volume of the dough is reached.

24. A household cooking appliance, comprising:
a treatment chamber designed for heat treatment of food introduced therein;
a camera designed to capture images from the treatment chamber; and
a data processing facility designed
to identify image points belonging to the food in one image of a sequence of images,
to calculate for subsequent images a movement direction and a movement speed of the image points using an optical flow method, in particular a dense optical flow method,
to classify movement directions of previously identified image points into classes for different movement directions,
to count numbers of image points which fall into respective ones of the classes,
to calculate from the numbers a variable relating to the volume of the food, and
to vary an operating parameter of the household cooking appliance influencing the treatment of the food, when the calculated variable satisfies a specified criterion.
